(19) United States
(12) Patent Application Publication
(10) Pub. No.: US 2024/0209843 A1
(43) Pub. Date: Jun. 27, 2024

(54) SCALABLE VOXEL BLOCK SELECTION

(71) Applicant: QUALCOMM Incorporated, San Diego, CA (US)

(72) Inventors: Adithya Reddy NALLABOLU, San Diego, CA (US); Gokce DANE, San Diego, CA (US); Pirazh KHORRAMSHAHI, San Diego, CA (US); Upal MAHBUB, Santee, CA (US)

(21) Appl. No.: 18/596,523

(22) Filed: Mar. 5, 2024

Related U.S. Application Data
(63) Continuation of application No. 18/301,178, filed on Apr. 14, 2023, now Pat. No. 11,959,465.
(60) Provisional application No. 63/332,196, filed on Apr. 18, 2022.

(51) Int. Cl. F03G 3/08; G01C 19/00; G01C 19/02; H02K 7/02; H02P 25/024

(52) U.S. Cl. CPC F03G 3/083; G01C 19/00; G01C 19/02; H02K 7/02; H02P 25/024

(57) ABSTRACT

Systems and techniques are described for performing scalable voxel block selection. For example, a computing device can determine a fixed block configuration based on a storage size limitation. The computing device can select a plurality of blocks of the scene based on the fixed block configuration. The computing device can convert indices of the plurality of blocks associated with the fixed block configuration to indices of a plurality of blocks associated with a particular block configuration (of a plurality of block configurations) that corresponds to a particular 3DR application. The particular block configuration is different from the fixed block configuration.

### FIELD

The present disclosure generally relates to image processing. For example, aspects of the present disclosure relate to scalable voxel block selection.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

In recent decades, there has been a demand for 3D content for computer graphics, virtual reality, and communications, triggering a change in emphasis for the requirements. Many existing systems for constructing 3D models are built around specialized hardware resulting in a high cost, which often cannot satisfy the requirements of these new applications. This need has stimulated the use of digital imaging facilities (e.g., cameras) for 3D reconstruction.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for scalable voxel block selection. According to at least one example, an apparatus for three-dimensional reconstruction (3DR) of a scene is provided. The apparatus includes at least one memory and at least one processor coupled to the at least one memory and configured to: determine a fixed block configuration based on a storage size limitation; select a plurality of blocks of the scene based on the fixed block configuration; and convert indices of the plurality of blocks associated with the fixed block configuration to indices of a plurality of blocks associated with a particular block configuration corresponding to a particular 3DR application, wherein the particular block configuration is different from the fixed block configuration.

In another illustrative example, a method for 3DR of a scene is provided. The method includes: determining a fixed block configuration based on a storage size limitation; selecting a plurality of blocks of the scene based on the fixed block configuration; and converting indices of the plurality of blocks associated with the fixed block configuration to indices of a plurality of blocks associated with a particular block configuration corresponding to a particular 3DR application, wherein the particular block configuration is different from the fixed block configuration.

In another example, a non-transitory computer-readable medium is provided that has stored thereon instructions that, when executed by one or more processors, cause the one or more processors to: determine a fixed block configuration based on a storage size limitation; select a plurality of blocks of the scene based on the fixed block configuration; and convert indices of the plurality of blocks associated with the fixed block configuration to indices of a plurality of blocks associated with a particular block configuration corresponding to a particular 3DR application, wherein the particular block configuration is different from the fixed block configuration.

In another example, an apparatus for generating virtual content at a first device in a distributed system is provided. The apparatus includes: means for determining a fixed block configuration based on a storage size limitation; means for selecting a plurality of blocks of the scene based on the fixed block configuration; and means for converting indices of the plurality of blocks associated with the fixed block configuration to indices of a plurality of blocks associated with a particular block configuration corresponding to a particular 3DR application, wherein the particular block configuration is different from the fixed block configuration.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus includes an image sensor (e.g., a camera) or multiple image sensors (e.g., multiple cameras) for capturing one or more images. In some aspects, each apparatus includes one or more displays for displaying one or more images, notifications, and/or other displayable data. In some aspects, each apparatus includes one or more speakers, one or more light-emitting devices, and/or one or more microphones. In some aspects, each apparatus described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram illustrating an example device that may employ a color metadata buffer for 3D reconstruction, in accordance with some examples.

FIG. 4 is a diagram illustrating an example of a 3D surface reconstruction of a scene modeled as a volume grid, in accordance with some examples.

FIG. 5 is a diagram illustrating an example of a hash mapping function for indexing blocks (e.g., voxel blocks) in a volume grid, in accordance with some examples.

FIG. 6 is a diagram illustrating an example of a block (e.g., a voxel block), in accordance with some examples.

FIG. 7 is a diagram illustrating an example of a truncated signed distance function (TSDF) volume reconstruction, in accordance with some examples.

FIG. 8 is a diagram illustrating an example of a voxel block selection algorithm, in accordance with some examples.

FIG. 9 is a diagram illustrating an example of a scalable voxel block selection algorithm that utilizes a fixed block configuration, in accordance with some examples.

FIG. 10 is a flow diagram illustrating an example of a process for operation of the scalable voxel block selection algorithm of FIG. 9, in accordance with some examples.

FIG. 11 is a table illustrating examples of different voxel block configurations with corresponding hardware cache requirements, in accordance with some examples.

FIG. 12 is a diagram illustrating an example of a scalable voxel block selection algorithm that utilizes a fixed block configuration, where an example of a fixed block configuration and an example of a particular block configuration are illustrated, in accordance with some examples.

FIG. 13 is a flow diagram illustrating an example of a process for 3D reconstruction, in accordance with some examples.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D color frame to determine the depth and color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of 1 or 0), based on a depth range, or from a confidence of the depth predictions. In some cases, a block selection algorithm can select a block if a single depth pixel is determined to be located in the block. In such cases, there may be no need for a counter and thresholding, or a block can be selected if a counter is equal to 1.

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, integration, and surface extraction. During block selection, blocks that have surfaces or are located close to a surface can be selected. These blocks can then be allocated into memory. In block integration, all voxel blocks within a block volume can be iterated over and an updated TSDF value weight can be calculated. In surface extraction, marching cubes can be used to determine triangular surfaces in the blocks.

In block selection, depth pixels can be iterated over to unproject them to a 3D space and determine where they lie within the 3D space using intrinsic and extrinsic camera parameters. Typically, a hash map is employed for block selection. A hash map is an unordered map that includes a listing of blocks (e.g., including block indices of the blocks) that have a surface. The hash map can include a corresponding counter for each of the blocks that maintains a count of the number of times depth pixels lie within the particular block. A threshold (e.g., threshold value or number) can be used to select all the blocks that have depth pixels lie within them for more than the threshold number of times. The selected blocks can then be integrated.

The cache size (e.g., size of the hardware for the cache memory, which can be used to store the hash map) can depend upon the depth range, sample distances, block size, etc. The requirement for the cache size (e.g., requirement for the size of the hardware for the cache) can increase with cubic order with an increase in sample distances and/or block sizes, and can be significantly large, especially for smaller sample distances and/or smaller block sizes. As such, the requirement for the cache size (e.g., for storing the hash map) can be a bottleneck for the operation of a block selection algorithm for block selection. With a finite hardware cache size (e.g., to store the hash map), there can be a strong probability for collisions and overflow of the hash index array, which can force block indices to be dropped (e.g., deleted from the cache). When block indices are dropped, an unpleasant randomness can be induced in the block selection algorithm because the outputs of the algorithm may not be consistent. To eliminate this randomness, a large overflow buffer (e.g., which is not scalable) may be required. Current 3DR hardware algorithms are not flexible to support all 3DR configurations with a limited cache size. As such, systems and techniques to provide a scalable block selection algorithm with a finite hardware cache size can be beneficial.

In one or more aspects, systems, apparatuses, processes (also referred to as methods), and computer-readable media (collectively referred to herein as “systems and techniques”) are described herein for performing scalable voxel block selection. For instance, a scalable voxel block selection algorithm can be performed for systems with a finite hardware cache. In one or more examples, for 3DR, in block selection, blocks are selected that have surfaces inside or close to the block volumes. Since 3DR algorithms operate with varying 3DR configurations, hardware may be designed to support all these configurations. The systems and techniques provide a scalable efficient hardware block selection algorithm, which supports all 3DR block configurations with a finite cache size.

In one or more aspects, the systems and techniques provide a modified block selection algorithm. Instead of selecting block volumes with varying 3DR configurations (e.g., as typically performed by existing block selection algorithms), the systems and techniques provide a block selection algorithm that selects a 3D space using a fixed configuration. In some cases, the systems and techniques described herein are not limited to one single fixed configuration. For example, different fixed configurations can be used for different input settings or applications. By using the selected 3D space with a fixed configuration, selected block indices can be converted utilizing a simple conversion based on the 3DR configuration (e.g., a desired use case 3DR configuration for a particular 3DR application). Using a fixed configuration can remove the variable hardware cache requirement such that all 3DR block configurations can be supported.

Using a fixed configuration can allow for a hardware design (e.g., a cache hardware design) agnostic to the different 3DR block configurations, while being scalable to support multiple 3DR configurations. The hardware cache can be designed with a fixed configuration that can avoid overloading a hash index array with certainty. Using a fixed configuration can remove the unpleasant randomness in the output of the blocks selection algorithm. By operating a block selection algorithm with a fixed configuration, the uncertainty with a finite hash map can be removed and also the need for an overflow buffer can be eliminated. The use of a fixed configuration may incur a slight increase in the number of blocks integrated.

In one or more aspects, during operation of the systems and techniques for 3DR of a scene, a fixed block configuration can be determined based on a storage size limitation. In one or more examples, the storage size limitation is a cache size limitation. A plurality of blocks of the scene can be selected based on the fixed block configuration. In one or more examples, each block of the plurality of blocks is a voxel block. Indices of the plurality of blocks associated with the fixed block configuration can be converted to indices of a plurality of blocks associated with a particular block configuration (of a plurality of block configurations) corresponding to a particular 3DR application. The particular block configuration is different from the fixed block configuration.

In some examples, determining the fixed block configuration may be further based on a lookup table (LUT) mapping the plurality of block configurations to associated respective required cache sizes, where the plurality of block configurations includes the fixed block configuration.

In one or more examples, selecting the plurality of blocks can involve obtaining a plurality of depth pixels associated with a plurality of depth maps of the scene, where each depth map of the plurality of depth maps is associated with a respective pose of an image sensor, and wherein each depth pixel of the plurality of depth pixels is associated with a depth value; converting depth values of the plurality of depth pixels to a plurality of global three-dimensional (3D) points in a global coordinate system; determining indices of blocks associated with the plurality of global 3D points; generating a listing of blocks including the indices of the blocks associated with the plurality of global 3D points and indices of neighboring blocks adjacent to the blocks associated with the plurality of global 3D points; and selecting the plurality of blocks of the scene from the listing of blocks based on a number of depth pixels of the plurality of depth pixels being located within the plurality of blocks.

In some examples, a counter for each block in the listing of blocks can be incremented each time a depth pixel of the plurality of depth pixels is located within each block. Blocks in the listing of blocks with a counter value greater than a threshold value can be determined. The plurality of blocks of the scene can be selected based on the blocks in the listing of the blocks having a counter value greater than the threshold value. In some cases, a block can be selected if a single depth pixel is determined to be located in the block (e.g., the threshold value is equal to 1). In some aspects, when there may be no need for a counter and thresholding, or a block can be selected if a counter is equal to 1.

In one or more examples, converting the depth values of the plurality of depth pixels to the plurality of global 3D points in the global coordinate system involves unprojecting the depth values to a 3D space.

In some examples, a scaling ratio and offsets between the fixed block configuration and the particular block configuration can be determined. In one or more examples, converting the indices of the plurality of blocks associated with the fixed block configuration to the indices of the plurality of blocks associated with the particular block configuration is based on the scaling ratio and the offsets between the fixed block configuration and the particular block configuration.

The systems and techniques provide a number of advantages. For example, the systems and techniques allow for a scalable hardware 3DR system. For another example, the systems and techniques provide a hardware block selection algorithm that can support all possible 3DR block configurations. The disclosed hardware block selection algorithm can remove unpleasant randomness in the block selection output by operating with a fixed configuration. The systems and techniques can also remove noisy artifacts in front of the surfaces by selecting a larger space around a surface for block integrations.

Additional aspects of the present disclosure are described in more detail below.

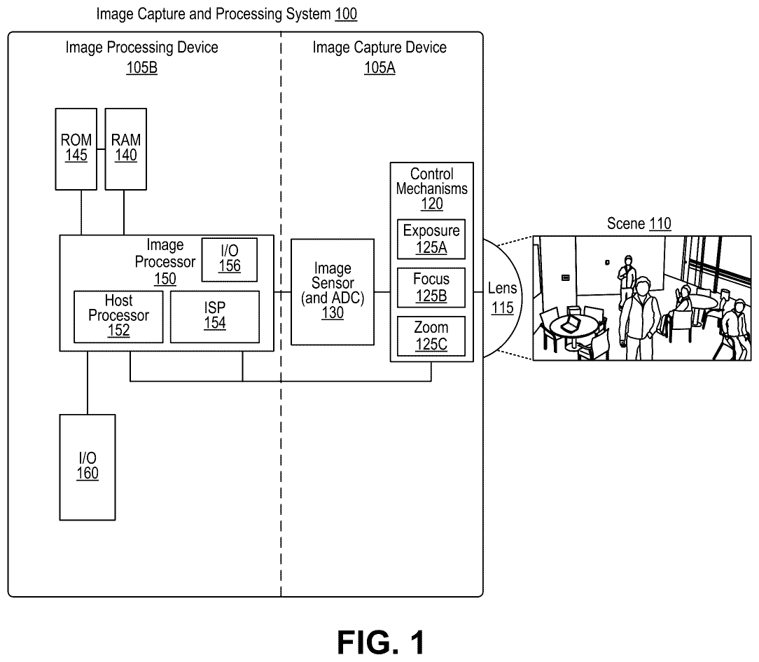

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1210 discussed with respect to the computing system 1200. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1120, read-only memory (ROM) 145/1125, a cache 1112, a memory unit 1115, another storage device 1130, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

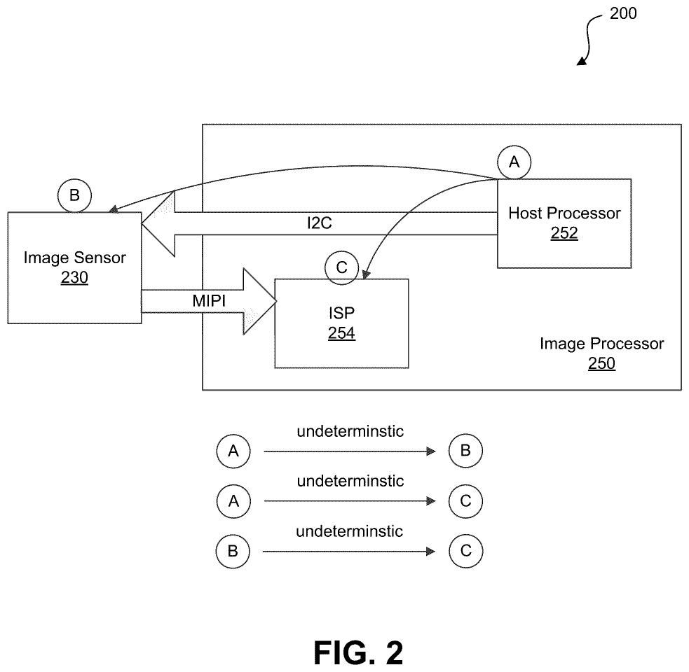

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

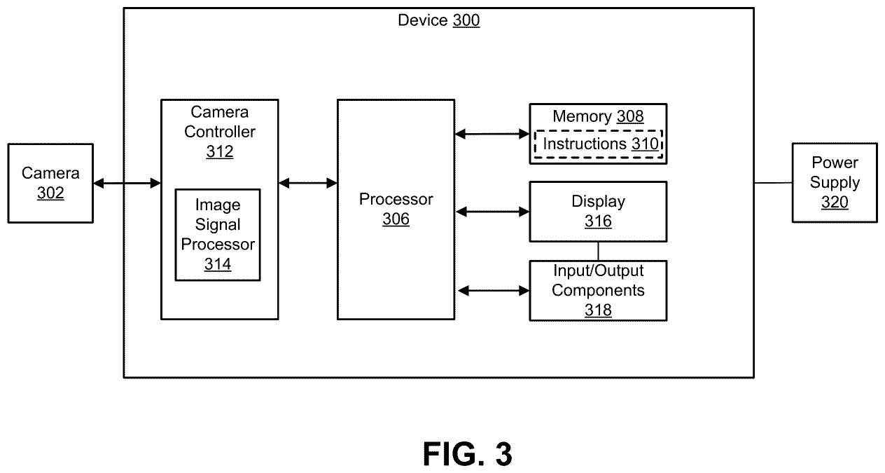

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

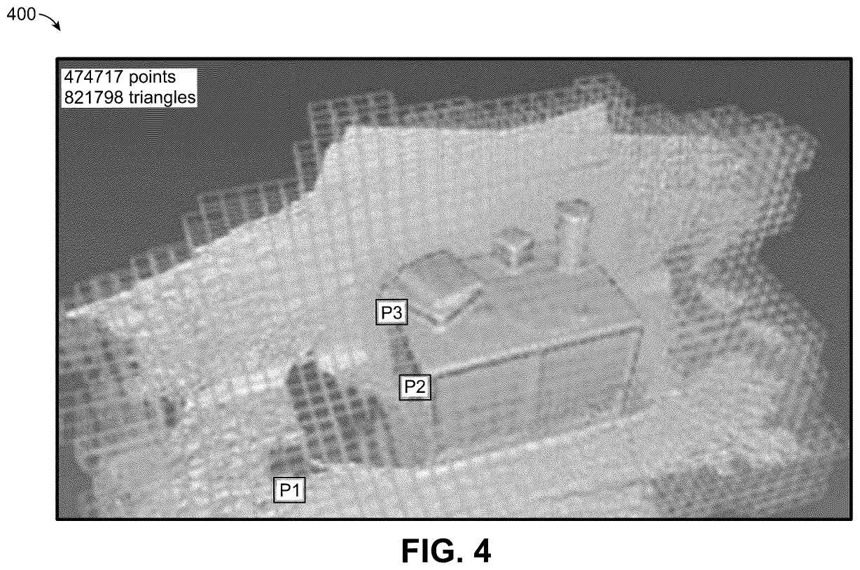

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

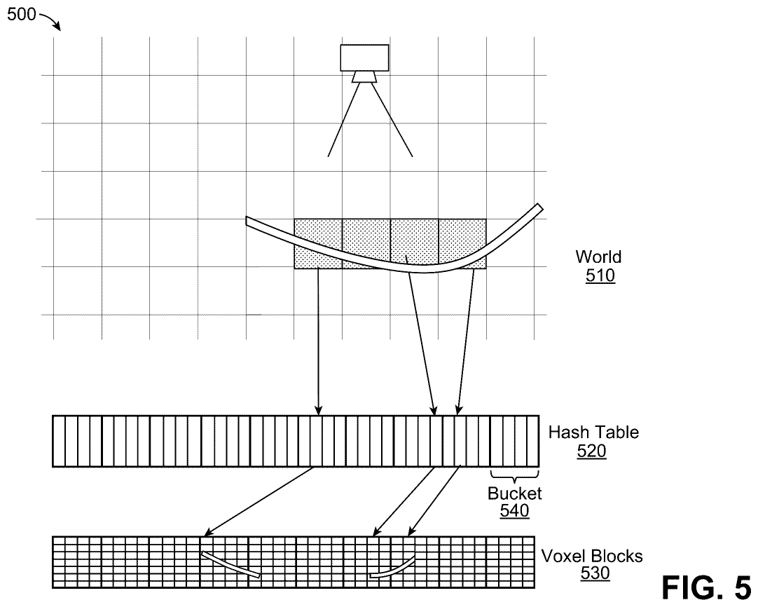

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

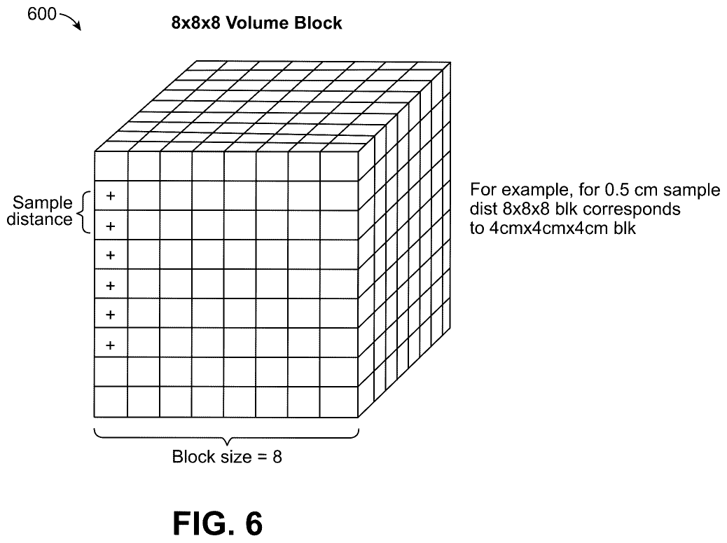

FIG. 6 is a diagram illustrating an example of a volume block (e.g., a voxel block) 600. In FIG. 6, the voxel block 600 is shown to have a block size of eight. For example, a 0.5 centimeter (cm) sample distance for an eight by eight by eight voxel block can correspond to a four cm by four cm by four cm voxel block.

In one or more examples, each voxel block (e.g., voxel block 600) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$\begin{matrix}tsdf = \{ \begin{matrix}- 1 , & if d \leq - ramp \\ \frac{d}{ramp} , & if - ramp < d < ramp \\ 1 , & if d \geq ramp\end{matrix} \} \\ sample . tsdf = ( \frac{sample . weight * sample . tsdf + tsdf}{sample . weight + 1} )\end{matrix} \qquad Equation ( 1 )$$

A TSDF integration or fusion process can be employed that updates the TSDF values and weights with each new observation from the sensor (e.g., camera).

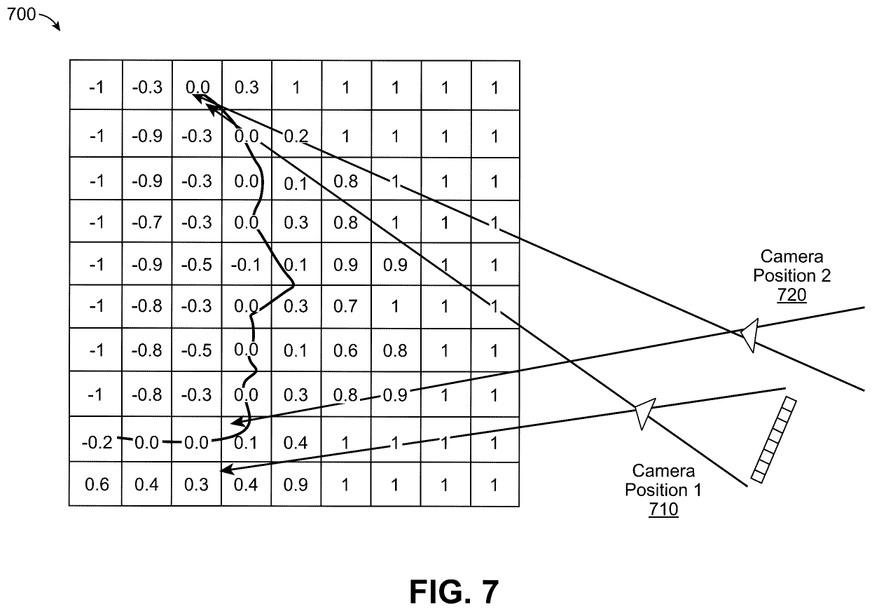

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as 1 or 0), based on a depth range, or from a confidence of the depth predictions. In some cases, a block selection algorithm can select a block if a single depth pixel is determined to be located in the block. In such cases, there may be no need for a counter and thresholding, or a block can be selected if a counter is equal to 1.

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

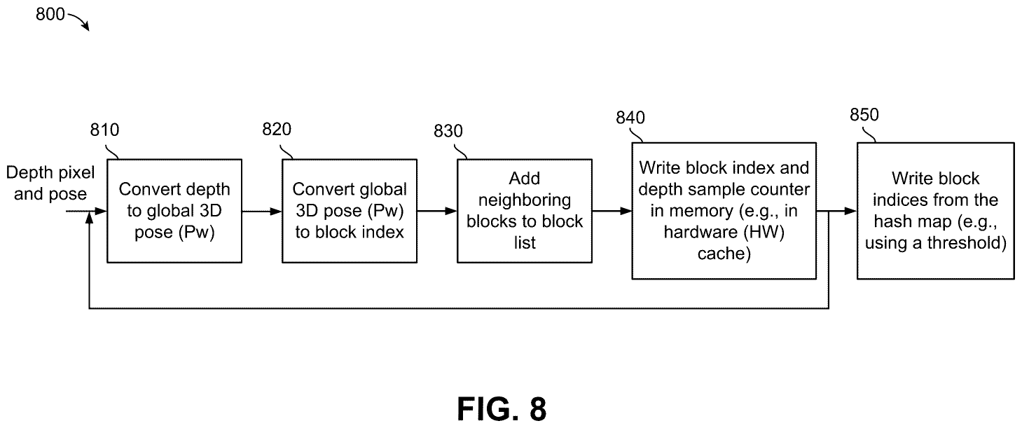

FIG. 8 shows an example voxel block selection algorithm for 3DR of a scene. In particular, FIG. 8 is a diagram illustrating an example of a voxel block selection algorithm 800. In FIG. 8, for operation of the voxel block selection algorithm 800, a plurality of depth pixels associated with a plurality of depth maps of the scene can be obtained by one or more processors (e.g., ISP 154 of FIG. 1, ISP 254 of FIG. 2, and/or image signal processor 314 of FIG. 3). In one or more examples, each depth map of the plurality of depth maps is associated with a respective pose (e.g., 6 DoF pose) of an image sensor (e.g., a camera, such as image capture device 105A, image sensor 230 of FIG. 2, or camera 302 of FIG. 3). In some examples, each depth pixel of the plurality of depth pixels is associated with a depth value. The one or more processors can iterate the algorithm 800 over every depth value in the depth maps.

During operation of the voxel block selection algorithm 800, at block 810, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space.

At block 810, the one or more processors can determine indices of blocks (e.g., voxel blocks) associated with the plurality of global 3D points. At block 830, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at block 840, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At block 850, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

The cache size (e.g., size of the hardware for the cache memory, which may store the hash map) can depend upon the depth range, sample distances, block size, etc. The requirement for the cache size (e.g., requirement for the size of the hardware for the cache) can increase with cubic order with an increase in sample distances and/or block sizes, and may be significantly large, especially for smaller sample distances and/or smaller block sizes. Thus, the requirement for the cache size (e.g., for storing the hash map) may be a bottleneck for the operation of a block selection algorithm for block selection. With a finite hardware cache size (e.g., for storing the hash map), there can be a strong probability for collisions and overflow of the hash index array, which may force block indices to be dropped (e.g., deleted from the cache). When block indices are dropped, an unpleasant randomness may be induced in the block selection algorithm because the outputs of the algorithm may not be consistent. To eliminate this randomness, a large overflow buffer (e.g., which is not scalable) can be required. Current 3DR hardware algorithms are not flexible to support all 3DR configurations with a limited cache size. Therefore, systems and techniques to provide a scalable block selection algorithm with a finite hardware cache size can be useful.

In one or more aspects, the systems and techniques provide a scalable voxel block selection algorithm with a finite hardware cache. In one or more examples, for 3DR, in block selection, blocks can be selected that have surfaces inside or close to the block volumes. Since 3DR algorithms operate with varying 3DR configurations, hardware needs to be designed to support all these configurations. The systems and techniques provide a scalable efficient hardware block selection algorithm, which can support all 3DR block configurations with a finite cache size.

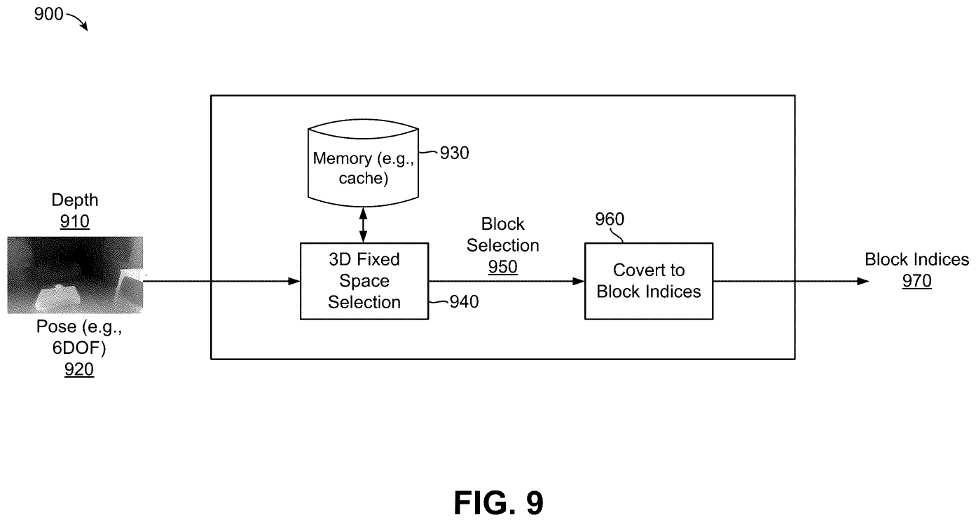

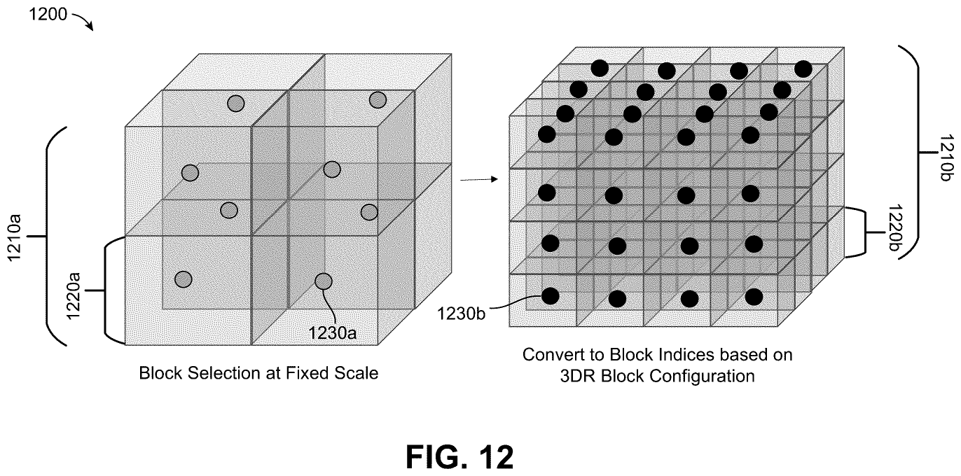

In one or more aspects, the systems and techniques provide a modified voxel block selection algorithm. Instead of selecting block volumes with varying 3DR configurations (e.g., as typically performed by existing block selection algorithms, such as the voxel block selection algorithm 800 of FIG. 8), the systems and techniques provide a block selection algorithm (e.g., voxel block selection algorithm 900 of FIG. 9 and voxel block selection algorithm 1200 of FIG. 12) that selects a 3D space using a fixed configuration (e.g., the configuration for voxel block 1210a as shown in FIG. 12). In some cases, the fixed configuration can be determined or selected from a number of available fixed configurations. By using the selected 3D space with a fixed configuration, selected block indices can be converted utilizing a simple conversion based on the 3DR configuration (e.g., a desired use case 3DR configuration for a particular 3DR application, such as the configuration for voxel block 1210b as shown in FIG. 12). Using a fixed configuration can remove the variable hardware cache requirement such that all 3DR block configurations may be supported.

Using a fixed configuration may allow for a hardware design (e.g., a cache hardware design) agnostic to the different 3DR block configurations, while being scalable to support multiple 3DR configurations. The hardware cache may be designed with a fixed configuration that can avoid overloading a hash index array with certainty. Using a fixed configuration may remove the unpleasant randomness in the output of the blocks selection algorithm. By operating a block selection algorithm with a fixed configuration, the uncertainty with a finite hash map may be removed and also the need for an overflow buffer can be eliminated. The use of a fixed configuration may incur a slight increase in the number of blocks integrated.

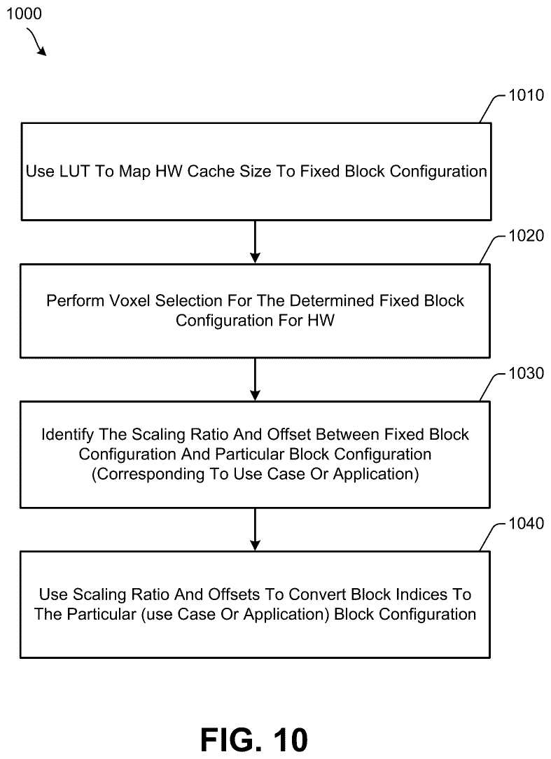

FIGS. 9 and 10 together illustrate operation of an example scalable voxel block selection algorithm 900. In particular, FIG. 9 is a diagram illustrating an example of a scalable voxel block selection algorithm 900 that utilizes a fixed block configuration. In FIG. 8, for operation of the voxel block selection algorithm 900, a plurality of depth pixels associated with a plurality of depth maps (e.g., depth map 910) of a scene can be obtained by one or more processors (e.g., ISP 154 of FIG. 1, ISP 254 of FIG. 2, and/or image signal processor 314 of FIG. 3). In one or more examples, each depth map of the plurality of depth maps is associated with a respective pose (e.g., 6 DoF pose, such as 6 DoF pose 920) of an image sensor (e.g., a camera, such as image capture device 105A, image sensor 230 of FIG. 2, or camera 302 of FIG. 3). In some examples, each depth pixel of the plurality of depth pixels is associated with a depth value.

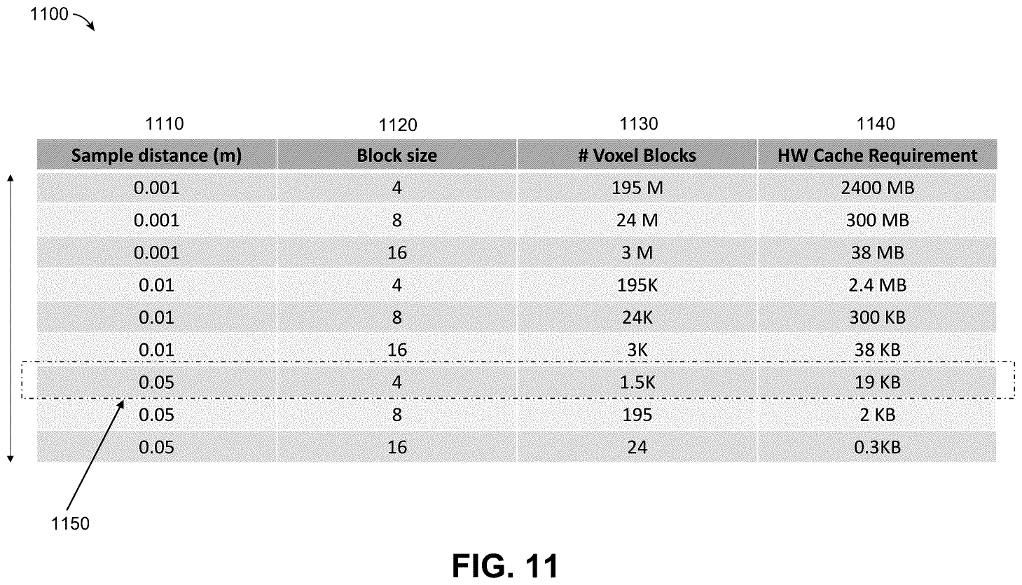

During operation of the scalable voxel block selection algorithm 900, at block 940, the one or more processors can determine a fixed block configuration based on a storage size limitation. In one or more examples, the storage size limitation may be a cache size limitation (e.g., a limitation of the size of hardware required for the cache memory, such as cache 930). In some examples, the determining of the fixed block configuration by the one or more processors can be further based on a lookup table (LUT), such as table 1100 of FIG. 11, mapping the plurality of block configurations to associated respective required cache sizes, where the plurality of block configurations includes the fixed block configuration (e.g., such as configuration 1150 of FIG. 11).

During operation of the algorithm 900, at arrow 950, the one or more processors can select a plurality of blocks of the scene based on the fixed block configuration (e.g., the configuration of voxel block 1210a as shown in FIG. 12). Each block of the plurality of blocks may be a voxel block (e.g., voxel block 1210a of FIG. 12). The one or more processors can iterate over every depth value in the depth maps for the selection of the plurality of blocks. For the selection of the plurality of the blocks, the one or more processors may convert the depth values of the plurality of depth pixels to a plurality of global 3D points in a global coordinate system. The converting of the depth values of the plurality of depth pixels to the plurality of global 3D points in the global coordinate system may be achieved by the one or more processors unprojecting the depth values to a 3D space. The one or more processors can then determine indices of blocks (e.g., voxel blocks) associated with the plurality of global 3D points. The one or more processors may generate a listing of blocks including the indices of the blocks associated with the plurality of global 3D points and indices of neighboring blocks adjacent (e.g., next to or close) to the blocks associated with the plurality of global 3D points.

The one or more processors may then select the plurality of blocks of the scene from the listing of blocks based on a number of depth pixels of the plurality of depth pixels being located within the plurality of blocks. For an example, the one or more processors may increment a counter for each block in the listing of blocks each time a depth pixel of the plurality of depth pixels is located within each block. The one or more processors may then write the indices and the corresponding counter values of the blocks in the listing of the blocks in memory (e.g., a hardware cache, such as cache 930). The one or more processors may then determine blocks in the listing of blocks with a counter value greater than a threshold value (e.g., a threshold number). The one or more processors may then select the plurality of blocks of the scene based on the blocks in the listing of blocks with the counter value greater than the threshold value. The one or more processors may then write the indices of the selected plurality of blocks of the scene in memory (e.g., the hardware cache, such as cache 930).

At block 960, the one or more processors can then convert indices of the plurality of blocks (e.g., voxel block 1210a of FIG. 12) associated with the fixed block configuration (e.g., the configuration of voxel block 1210a as shown in FIG. 12) to indices of a plurality of blocks (e.g., voxel block 1210b of FIG. 12) associated with a particular block configuration (e.g., the configuration of voxel block 1210b as shown in FIG. 12) of a plurality of block configurations (e.g., different voxel block configurations as shown in table 1100 of FIG. 11). The particular block configuration corresponds to a particular 3DR application (or use case) and is different from the fixed block configuration.

In one or more examples, a particular block configuration may be a desired block configuration for a specific 3DR use case or application. Different 3DR use cases/applications can require different block configurations. For example, a use case (e.g., an autonomous driving 3DR use case or application) that requires a high resolution for 3DR may require a block configuration with a small sample distance between samples (e.g., samples 1230b of FIG. 12) within a voxel block (e.g., voxel block 1210b of FIG. 12). A block configuration with a small sample distance can typically have a large cache size requirement.

In one or more examples, the one or more processors can determine a scaling ratio and offsets between the fixed block configuration (e.g., the configuration of voxel block 1210a as shown in FIG. 12) and the particular block configuration (e.g., the configuration of voxel block 1210b as shown in FIG. 12). In one or more examples, the converting, by the one or more processors, of the indices of the plurality of blocks associated with the fixed block configuration to the indices of the plurality of blocks associated with the particular block configuration can be based on the determined scaling ratio and the offsets between the fixed block configuration and the particular block configuration.

For an example of converting an index of a block associated with a fixed block configuration to an index of a block associated with a particular block configuration, a voxel block associated with a fixed block configuration may have an index (e.g., a block index) of {bx1, by1, bz1}. The one or more processors may utilize an upscaling ratio and offsets to convert the index of {bx1, by1, bz1} of the voxel block associated with the fixed block configuration to an index of {(2*bx1, 2*by1, 2*bz1), (2*bx1+1, 2*by1, 2*bz1), (2*bx1, 2*by1+1, 2*bz1), (2*bx1, 2*by1, 2*bz1+1)} of a voxel block associated with the particular block configuration.

After the one or more processors convert indices of the plurality of blocks associated with the fixed block configuration to indices of the plurality of blocks associated with the particular block configuration, the one or more processors can then write the indices of the plurality of blocks (e.g., block indices 970) of the particular block configuration in memory (e.g., the hardware cache, such as cache 930).

FIG. 10 is a flow diagram illustrating an example of a process 1000 for operation of the scalable voxel block selection algorithm 900 of FIG. 9. During operation of the process 1000 of FIG. 10, at step 1010, one or more processors (e.g., ISP 154 of FIG. 1, ISP 254 of FIG. 2, and/or image signal processor 314 of FIG. 3) can use a lookup table (e.g., table 1100 of FIG. 11) to map the hardware cache size (e.g., size of cache 930 of FIG. 9) to an affordable block configuration (e.g., a fixed block configuration that allows for block indices to be maintained, and not dropped). At block 1020, the one or more processors can perform voxel block selection for the determined block configuration (e.g., the fixed block configuration) for the cache hardware. At block 1030, the one or more processors can identify (e.g., determine) a scaling ratio and offsets between the supported block configuration (e.g., the fixed block configuration) and an actual block configuration supported by a use case (e.g., a particular block configuration). At block 1040, the one or more processors can utilize the determined scaling ratio and offsets to convert the block indices of the determined block configuration (e.g., the fixed block configuration) to block indices of the use case block configuration (e.g., the particular block configuration).

FIG. 11 shows an illustrative example of a lookup table (LUT) including various different voxel block configurations with different corresponding hardware cache size requirements. The lookup table may be referred to (e.g., by the one or more processors) for choosing a fixed block configuration for operation of the algorithm 900 of FIG. 9. In particular, FIG. 11 is a table 1100 illustrating examples of different voxel block configurations with corresponding hardware cache requirements. In FIG. 11, the table is shown to include a plurality of columns, which include a sample distance 1110 column, a block size 1120 column, a number of voxel blocks 1130 column, and a hardware cache size requirement 1140 column.

The sample distance 1110 column of table 1100 of FIG. 11 shows different sample distances in meters (m). A sample distance is the distance (e.g., in meters) between two adjacent samples within the same voxel block. For example, as shown in FIG. 12, sample 1230a is an example of a sample within voxel block 1210a. Sample 1230b is an example of a sample within voxel block 1210b.

The block size 1120 column of table 1100 of FIG. 11 shows different block sizes for a voxel block. A block size is the number of voxels that a single voxel block contains. For example, as shown in FIG. 12, voxel block 1210a is a 4 by 4 by 4 block including a total of 8 voxels 1220a. As such, voxel block 1210a has a block size of 4. Voxel block 1210b of FIG. 12 is a 16 by 16 by 16 block including a total of 64 voxels 1220b. As such, voxel block 1210b has a block size of 16.

The number of voxels blocks 1130 column of table 1100 of FIG. 11 shows the number of voxel blocks (e.g., voxel block 1210a, 1210b of FIG. 12) used for a scene. For example, for block configuration 1150 (e.g., shown in the seventh row of the table 1100), a total of 1.5K voxel blocks are to be used for the scene. The hardware cache size requirement 1140 column of table 1100 of FIG. 11 shows the hardware cache size requirement (e.g., in bytes (B)) for the 3DR of the scene. For example, for the block configuration 1150, a hardware cache size of 19 kilobytes (KB) is required.

Each row in the table 1110 of FIG. 11 shows an example of a block configuration. For example, the seventh row in the table 1110 shows a block configuration 1150 that only requires a cache size of 19 KB. Since this block configuration 1150 has a low cache size requirement, this block configuration 1150 may be utilized as a fixed block configuration for the algorithm 900 of FIG. 9. For example, this block configuration 1150 may be utilized as a fixed block configuration when the algorithm 900 is utilizing any of the block configurations (e.g., particular block configurations, which may be actual use case block configurations) shown in the rows above the seventh row (e.g., any of the block configurations in the first six rows of table 1100).

FIG. 12 is a diagram 1200 that shows examples of different voxel blocks 1210a, 1210b as well as shows algorithm 900 of FIG. 9. In particular, FIG. 12 is a diagram illustrating an example of a scalable voxel block selection algorithm 900 that utilizes a fixed block configuration, where an example of a fixed block configuration (e.g., the configuration of voxel block 1210a) and an example of a particular block configuration (e.g., the configuration of voxel block 1210b) are illustrated.

In FIG. 12, two example voxel blocks 1210a, 1210b are shown. As mentioned, voxel block 1210a is a 4 by 4 by 4 block including a total of 8 voxels 1220a and, as such, voxel block 1210a has a block size of 4. Voxel block 1210b of FIG. 12 is a 16 by 16 by 16 block including a total of 64 voxels 1220b and, as such, voxel block 1210b has a block size of 16.

Each of the eight voxels 1220a of voxel block 1210a is shown to include a sample 1230a. As such, voxel block 1210a includes a total of 8 samples. Similarly, each of the 64 voxels 1220b of voxel block 1210b is shown to include a sample 1230b. As such, voxel block 1210b includes a total of 64 samples.

The voxel block 1210a (e.g., with a block size of 4) has a smaller block size than the voxel block 1220b (e.g., with a block size of 16). As such, the configuration of the voxel block 1210a may have a smaller cache size requirement than the configuration of the voxel 1210b. Therefore, for the algorithm 900 of FIG. 9, the configuration of the voxel 1210a may be used as the fixed block configuration, when the configuration of the voxel 1210b is the particular block configuration being used (e.g., for a specific use case).

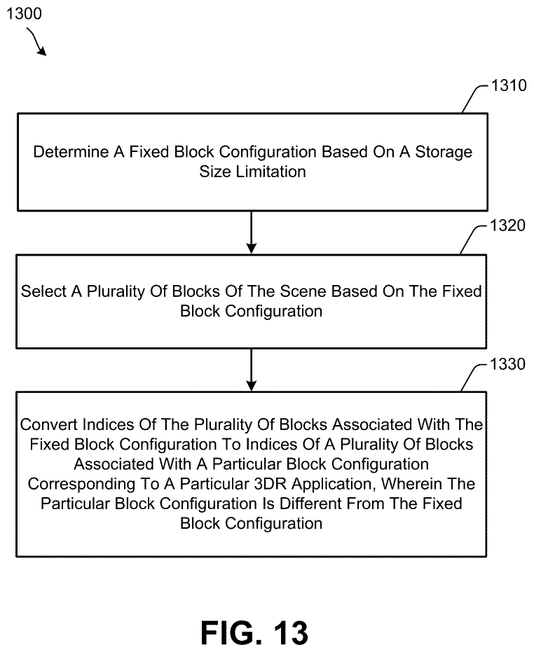

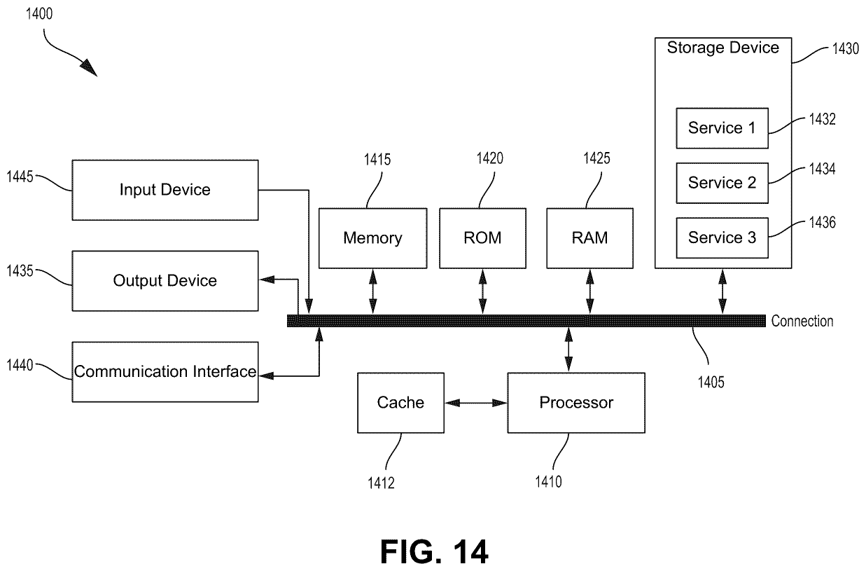

FIG. 13 is a flow chart illustrating an example of a process 1300 for 3D reconstruction of a scene. The process 1300 can be performed by a computing device (e.g., image processing device 105B of FIG. 1, image capture and processing system 200 of FIG. 2, device 300 of FIG. 3, a computing device or computing system 1400 of FIG. 14) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14 or other processor(s)). Further, the transmission and reception of signals by the computing device in the process 1300 may be enabled, for example, by one or more antennas and/or one or more transceivers (e.g., wireless transceiver(s)).

At block 1310, the computing device (or component thereof) can determine a fixed block configuration based on a storage size limitation (e.g., of a memory or storage device, such as a cache memory). For example, the storage size limitation may be a cache size limitation of a cache memory (e.g., cache 1412 of FIG. 14). In some aspects, the computing device (or component thereof) can determine the fixed block configuration further based on a lookup table (LUT) (e.g., the LUT 1100 of FIG. 11). The LUT can map the plurality of block configurations to associated respective required cache sizes. The plurality of block configurations include the fixed block configuration.

At block 1320, the computing device (or component thereof) can select a plurality of blocks (e.g., voxel blocks) of the scene based on the fixed block configuration. In some cases, the computing device (or component thereof) can obtain a plurality of depth pixels associated with a plurality of depth maps of the scene. Each depth map of the plurality of depth maps is associated with a respective pose of an image sensor. Each depth pixel of the plurality of depth pixels is associated with a depth value. The computing device (or component thereof) can convert depth values of the plurality of depth pixels to a plurality of global three-dimensional (3D) points in a global coordinate system. The computing device (or component thereof) can determine indices of blocks associated with the plurality of global 3D points and can generate a listing of blocks. The listing of blocks can include the indices of the blocks associated with the plurality of global 3D points and indices of neighboring blocks adjacent to the blocks associated with the plurality of global 3D points. The computing device (or component thereof) can select the plurality of blocks of the scene from the listing of blocks based on a number of depth pixels of the plurality of depth pixels being located within the plurality of blocks.

In some aspects, the computing device (or component thereof) can increment a counter for each block in the listing of blocks each time a depth pixel of the plurality of depth pixels is located within each block. The computing device (or component thereof) can determine blocks in the listing of blocks with a counter value greater than a threshold value and can select the plurality of blocks of the scene based on the blocks in the listing of blocks with the counter value greater than the threshold value. In some cases, a block selection algorithm can select a block if a single depth pixel is determined to be located in the block. In such cases, there may be no need for a counter and thresholding, or a block can be selected if a counter is equal to 1.

At block 1330, the computing device (or component thereof) can convert indices of the plurality of blocks associated with the fixed block configuration to indices of a plurality of blocks associated with a particular block configuration (of a plurality of block configurations) that corresponds to a particular 3DR application. The particular block configuration is different from the fixed block configuration. In some cases, to convert the depth values of the plurality of depth pixels to the plurality of global 3D points in the global coordinate system, the computing device (or component thereof) can the computing device (or component thereof) can unproject the depth values to a 3D space. In some aspects, the computing device (or component thereof) can determine a scaling ratio and offsets between the fixed block configuration and the particular block configuration. In some cases, the computing device (or component thereof) can convert the indices of the plurality of blocks associated with the fixed block configuration to the indices of the plurality of blocks associated with the particular block configuration based on the scaling ratio and the offsets between the fixed block configuration and the particular block configuration.

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed for a scalable voxel block selection algorithm with a finite hardware cache. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LIDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically crasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically crasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A method for three-dimensional reconstruction (3DR) of a scene, the method comprising: determining a fixed block configuration based on a storage size limitation; selecting a plurality of blocks of the scene based on the fixed block configuration; and converting indices of the plurality of blocks associated with the fixed block configuration to indices of a plurality of blocks associated with a particular block configuration (e.g., of a plurality of block configurations) corresponding to a particular 3DR application, wherein the particular block configuration is different from the fixed block configuration.
Aspect 2. The method of Aspect 1, wherein determining the fixed block configuration is further based on a lookup table (LUT) mapping the plurality of block configurations to associated respective required cache sizes, wherein the plurality of block configurations comprises the fixed block configuration.
Aspect 3. The method of any of Aspects 1 or 2, wherein selecting the plurality of blocks comprises: obtaining a plurality of depth pixels associated with a plurality of depth maps of the scene, wherein each depth map of the plurality of depth maps is associated with a respective pose of an image sensor, and wherein each depth pixel of the plurality of depth pixels is associated with a depth value; converting depth values of the plurality of depth pixels to a plurality of global three-dimensional (3D) points in a global coordinate system; determining indices of blocks associated with the plurality of global 3D points; generating a listing of blocks comprising the indices of the blocks associated with the plurality of global 3D points and indices of neighboring blocks adjacent to the blocks associated with the plurality of global 3D points; and selecting the plurality of blocks of the scene from the listing of blocks based on a number of depth pixels of the plurality of depth pixels being located within the plurality of blocks.
Aspect 4. The method of Aspect 3, further comprising: incrementing a counter for each block in the listing of blocks each time a depth pixel of the plurality of depth pixels is located within each block; determining blocks in the listing of blocks with a counter value greater than a threshold value; and selecting the plurality of blocks of the scene based on the blocks in the listing of blocks with the counter value greater than the threshold value.
Aspect 5. The method of any of Aspects 3 or 4, wherein converting the depth values of the plurality of depth pixels to the plurality of global 3D points in the global coordinate system comprises unprojecting the depth values to a 3D space.
Aspect 6. The method of any of Aspects 1 to 5, further comprising determining a scaling ratio and offsets between the fixed block configuration and the particular block configuration.
Aspect 7. The method of Aspect 6, wherein converting the indices of the plurality of blocks associated with the fixed block configuration to the indices of the plurality of blocks associated with the particular block configuration is based on the scaling ratio and the offsets between the fixed block configuration and the particular block configuration.
Aspect 8. The method of any of Aspects 1 to 7, wherein each block of the plurality of blocks is a voxel block.
Aspect 9. The method of any of Aspects 1 to 8, wherein the storage size limitation is a cache size limitation.
Aspect 10. The method of any of Aspects 1 to 9, further comprising processing the plurality of blocks associated with the particular block configuration based on the particular 3DR application.
Aspect 11. An apparatus for three-dimensional reconstruction (3DR) of a scene, the apparatus comprising: at least one memory; and at least one processor coupled to the at least one memory and configured to: determine a fixed block configuration based on a storage size limitation; select a plurality of blocks of the scene based on the fixed block configuration; and convert indices of the plurality of blocks associated with the fixed block configuration to indices of a plurality of blocks associated with a particular block configuration (e.g., of a plurality of block configurations) corresponding to a particular 3DR application, wherein the particular block configuration is different from the fixed block configuration.
Aspect 12. The apparatus of Aspect 11, wherein the at least one processor is configured to determine the fixed block configuration further based on a lookup table (LUT) mapping the plurality of block configurations to associated respective required cache sizes, wherein the plurality of block configurations comprises the fixed block configuration.
Aspect 13. The apparatus of any of Aspects 11 or 12, wherein, to select the plurality of blocks, the at least one processor is configured to: obtain a plurality of depth pixels associated with a plurality of depth maps of the scene, wherein each depth map of the plurality of depth maps is associated with a respective pose of an image sensor, and wherein each depth pixel of the plurality of depth pixels is associated with a depth value; convert depth values of the plurality of depth pixels to a plurality of global three-dimensional (3D) points in a global coordinate system; determine indices of blocks associated with the plurality of global 3D points; generate a listing of blocks comprising the indices of the blocks associated with the plurality of global 3D points and indices of neighboring blocks adjacent to the blocks associated with the plurality of global 3D points; and select the plurality of blocks of the scene from the listing of blocks based on a number of depth pixels of the plurality of depth pixels being located within the plurality of blocks.
Aspect 14. The apparatus of Aspect 13, wherein the at least one processor is configured to: increment a counter for each block in the listing of blocks each time a depth pixel of the plurality of depth pixels is located within each block; determine blocks in the listing of blocks with a counter value greater than a threshold value; and select the plurality of blocks of the scene based on the blocks in the listing of blocks with the counter value greater than the threshold value.
Aspect 15. The apparatus of any of Aspects 13 or 14, wherein, to convert the depth values of the plurality of depth pixels to the plurality of global 3D points in the global coordinate system, the at least one processor is configured to unproject the depth values to a 3D space.
Aspect 16. The apparatus of any of Aspects 11 to 15, wherein the at least one processor is configured to determine a scaling ratio and offsets between the fixed block configuration and the particular block configuration.
Aspect 17. The apparatus of Aspect 16, wherein the at least one processor is configured to convert the indices of the plurality of blocks associated with the fixed block configuration to the indices of the plurality of blocks associated with the particular block configuration based on the scaling ratio and the offsets between the fixed block configuration and the particular block configuration.
Aspect 18. The apparatus of any of Aspects 11 to 17, wherein each block of the plurality of blocks is a voxel block.
Aspect 19. The apparatus of any of Aspects 11 to 18, wherein the storage size limitation is a cache size limitation.
Aspect 20. The apparatus of any of Aspects 11 to 19, wherein the at least one processor is configured to process the plurality of blocks associated with the particular block configuration based on the particular 3DR application.
Aspect 21. A non-transitory computer-readable medium having stored thereon instructions that, when executed by one or more processors, cause the one or more processors to perform operations according to any of Aspects 1 to 10.
Aspect 22. An apparatus for three-dimensional reconstruction (3DR) of a scene, the apparatus including one or more means for performing operations according to any of Aspects 1 to 10.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for three-dimensional reconstruction (3DR) of a scene, the method comprising:
determining a fixed block configuration based on a storage size limitation;
selecting a plurality of blocks of the scene based on the fixed block configuration; and
converting indices of the plurality of blocks associated with the fixed block configuration to indices of a plurality of blocks associated with a particular block configuration corresponding to a particular 3DR application, wherein the particular block configuration is different from the fixed block configuration.

2. The method of claim 1, wherein determining the fixed block configuration is further based on a lookup table (LUT) mapping a plurality of block configurations to associated respective required cache sizes, wherein the plurality of block configurations comprises the fixed block configuration.

3. The method of claim 1, wherein selecting the plurality of blocks comprises:
obtaining a plurality of depth pixels associated with a plurality of depth maps of the scene, wherein each depth map of the plurality of depth maps is associated with a respective pose of an image sensor, and wherein each depth pixel of the plurality of depth pixels is associated with a depth value;
converting depth values of the plurality of depth pixels to a plurality of global three-dimensional (3D) points in a global coordinate system;
determining indices of blocks associated with the plurality of global 3D points;
generating a listing of blocks comprising the indices of the blocks associated with the plurality of global 3D points and indices of neighboring blocks adjacent to the blocks associated with the plurality of global 3D points; and
selecting the plurality of blocks of the scene from the listing of blocks based on a number of depth pixels of the plurality of depth pixels being located within the plurality of blocks.

4. The method of claim 3, further comprising:
incrementing a counter for each block in the listing of blocks each time a depth pixel of the plurality of depth pixels is located within each block;
determining blocks in the listing of blocks with a counter value greater than a threshold value; and
selecting the plurality of blocks of the scene based on the blocks in the listing of blocks with the counter value greater than the threshold value.

5. The method of claim 3, wherein converting the depth values of the plurality of depth pixels to the plurality of global 3D points in the global coordinate system comprises unprojecting the depth values to a 3D space.

6. The method of claim 1, further comprising determining a scaling ratio and offsets between the fixed block configuration and the particular block configuration.

7. The method of claim 6, wherein converting the indices of the plurality of blocks associated with the fixed block configuration to the indices of the plurality of blocks associated with the particular block configuration is based on the scaling ratio and the offsets between the fixed block configuration and the particular block configuration.

8. The method of claim 1, wherein each block of the plurality of blocks is a voxel block.

9. The method of claim 1, wherein the storage size limitation is a cache size limitation.

10. The method of claim 1, further comprising processing the plurality of blocks associated with the particular block configuration based on the particular 3DR application.

11. An apparatus for three-dimensional reconstruction (3DR) of a scene, the apparatus comprising:
at least one memory; and
at least one processor coupled to the at least one memory and configured to:
determine a fixed block configuration based on a storage size limitation;
select a plurality of blocks of the scene based on the fixed block configuration; and
convert indices of the plurality of blocks associated with the fixed block configuration to indices of a plurality of blocks associated with a particular block configuration corresponding to a particular 3DR application, wherein the particular block configuration is different from the fixed block configuration.

12. The apparatus of claim 11, wherein the at least one processor is configured to determine the fixed block configuration further based on a lookup table (LUT) mapping a plurality of block configurations to associated respective required cache sizes, wherein the plurality of block configurations comprises the fixed block configuration.

13. The apparatus of claim 11, wherein, to select the plurality of blocks, the at least one processor is configured to:
obtain a plurality of depth pixels associated with a plurality of depth maps of the scene, wherein each depth map of the plurality of depth maps is associated with a respective pose of an image sensor, and wherein each depth pixel of the plurality of depth pixels is associated with a depth value;
convert depth values of the plurality of depth pixels to a plurality of global three-dimensional (3D) points in a global coordinate system;
determine indices of blocks associated with the plurality of global 3D points;
generate a listing of blocks comprising the indices of the blocks associated with the plurality of global 3D points and indices of neighboring blocks adjacent to the blocks associated with the plurality of global 3D points; and
select the plurality of blocks of the scene from the listing of blocks based on a number of depth pixels of the plurality of depth pixels being located within the plurality of blocks.

14. The apparatus of claim 13, wherein the at least one processor is configured to:
increment a counter for each block in the listing of blocks each time a depth pixel of the plurality of depth pixels is located within each block;
determine blocks in the listing of blocks with a counter value greater than a threshold value; and
select the plurality of blocks of the scene based on the blocks in the listing of blocks with the counter value greater than the threshold value.

15. The apparatus of claim 13, wherein, to convert the depth values of the plurality of depth pixels to the plurality of global 3D points in the global coordinate system, the at least one processor is configured to unproject the depth values to a 3D space.

16. The apparatus of claim 11, wherein the at least one processor is configured to determine a scaling ratio and offsets between the fixed block configuration and the particular block configuration.

17. The apparatus of claim 16, wherein the at least one processor is configured to convert the indices of the plurality of blocks associated with the fixed block configuration to the indices of the plurality of blocks associated with the particular block configuration based on the scaling ratio and the offsets between the fixed block configuration and the particular block configuration.

18. The apparatus of claim 11, wherein each block of the plurality of blocks is a voxel block.

19. The apparatus of claim 11, wherein the storage size limitation is a cache size limitation.

20. The apparatus of claim 11, wherein the at least one processor is configured to process the plurality of blocks associated with the particular block configuration based on the particular 3DR application.
